(19) United States
(12) Patent Application Publication
(10) Pub. No.: US 2026/0291964 A1
(43) Pub. Date: Sep. 24, 2026

(54) HIERARCHICAL SHARED RISK MODELING FOR PRIVATE 5G SERVICES

(71) Applicant: Cisco Technology, Inc., San Jose, CA (US)

(72) Inventors: Navdeep SOOD, Bengaluru (IN); Praveen KUMAR, Bengaluru (IN)

(21) Appl. No.: 19/084,184

(22) Filed: Mar. 19, 2025

(51) Int. Cl. H04L 9/40; H04L 41/12

(52) U.S. Cl. CPC H04L 63/1425; H04L 41/12; H04L 63/1441

(57) ABSTRACT

In one embodiment, a method herein comprises: identifying shared risk entities within a layered network topology, each shared risk entity of the shared risk entities corresponding to a network component of the layered network topology associated with a common failure dependency; assigning a shared risk parameter to each shared risk entity, wherein the shared risk parameter comprises a shared risk type and an associated shared risk value; constructing a hierarchical shared risk model representing dependencies among the shared risk entities across multiple layers of the layered network topology, wherein the hierarchical shared risk model defines risk propagation paths between the shared risk entities according to the dependencies; and storing the hierarchical shared risk model as a data structure with each shared risk entity represented with a key-value pair comprising a respective shared risk type and respective shared risk value.

### TECHNICAL FIELD

The present disclosure relates generally to computer networks, and, more particularly, to hierarchical shared risk modeling for private 5G services.

### BACKGROUND

The rollout of 5G networks has introduced high-speed, low-latency connectivity that supports a wide range of applications, from autonomous vehicles and industrial automation to mission-critical healthcare systems. Unlike previous generations, 5G extends beyond mobile devices, serving as a backbone for private enterprise networks and fixed wireless broadband solutions. These networks rely on complex infrastructures, including core routers, radio access network (RAN) components, and fiber backhaul links, all of which introduce potential points of failure.

As 5G adoption expands, network resilience becomes a critical challenge due to shared dependencies across power sources, fiber links, and hardware components. A single infrastructure failure can propagate across multiple network layers, disrupting critical enterprise services. While redundancy mechanisms like macro-diversity improve signal robustness, they do not account for shared risk factors at the physical infrastructure level. As industries increasingly rely on real-time data transmission, hidden dependencies and cascading failures present a growing risk to service reliability, safety, and business continuity.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example open radio access network (O-RAN) system;

FIG. 4 illustrates an example mobile network (e.g., O-RAN) architecture from the management point of view;

FIG. 5 illustrates a simplified view of a 5G network;

FIG. 6 illustrates a chart of shared risk categorization;

FIG. 7 illustrates a hierarchical shared risk model;

FIG. 8 illustrates a scenario visualizing the shared risk impact of a failure event within this hierarchical shared risk model as in FIG. 7;

FIG. 9 illustrates an example procedure for hierarchical shared risk modeling for private 5G services; and

FIG. 10 illustrates another example procedure for hierarchical shared risk modeling for private 5G services.

### DESCRIPTION OF EXAMPLE EMBODIMENTS

### Overview

According to one or more embodiments of the disclosure, hierarchical shared risk modeling for private 5G services is provided herein. In particular, in one embodiment, a method herein comprises: identifying shared risk entities within a layered network topology, each shared risk entity of the shared risk entities corresponding to a network component of the layered network topology associated with a common failure dependency; assigning a shared risk parameter to each shared risk entity, wherein the shared risk parameter comprises a shared risk type and an associated shared risk value; constructing a hierarchical shared risk model representing dependencies among the shared risk entities across multiple layers of the layered network topology, wherein the hierarchical shared risk model defines risk propagation paths between the shared risk entities according to the dependencies; and storing the hierarchical shared risk model as a data structure with each shared risk entity represented with a key-value pair comprising a respective shared risk type and respective shared risk value.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

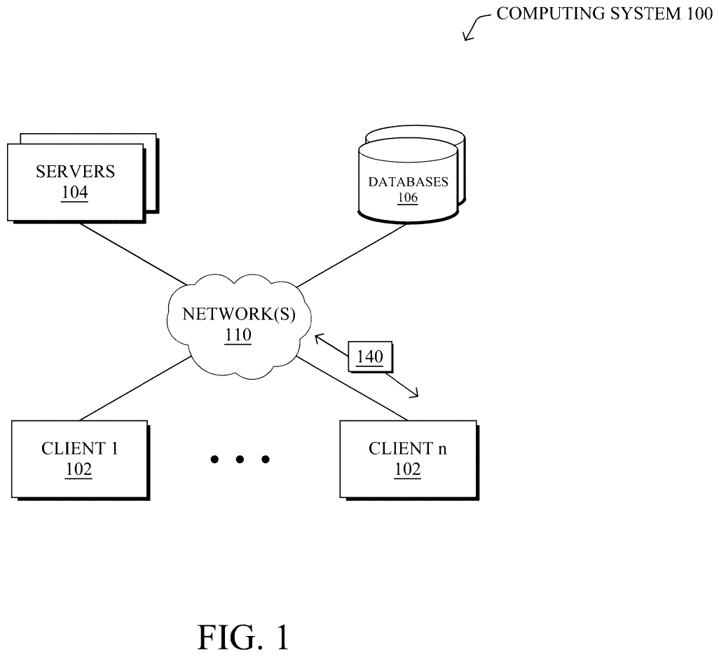

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

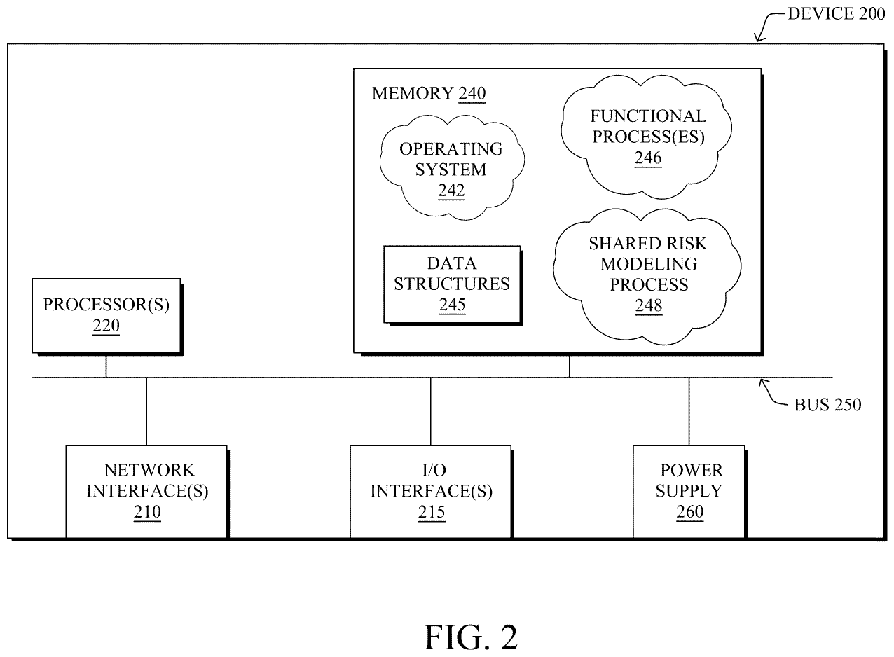

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a shared risk modeling process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

In various implementations, as detailed further below, one or more functional processes 246 and/or shared risk modeling process (process 248) may include computer executable instructions that, when executed by processor(s) 220, cause device 200 to perform the techniques described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

Cellular networks are the backbone of modern connectivity, enabling billions of devices worldwide to communicate with each other. At their core, cellular networks are systems of interconnected radio towers and base stations that provide wireless communication to mobile devices. These networks rely on a series of protocols and technologies to ensure reliable and efficient communication, from voice calls to high-speed internet access. Cellular networks are structured in layers, with the Radio Access Network (RAN) serving as the critical interface between user devices and the network core.

The evolution of cellular networks has been driven by the increasing demand for faster speeds, higher reliability, and the ability to support a growing variety of devices and services. Early networks, like 2G and 3G, focused primarily on voice communication and basic data transfer. With the advent of 4G, broadband internet access became a reality for mobile users, enabling high-speed data services like streaming and video calls. Currently, 5G is revolutionizing the landscape by promising ultra-reliable, low-latency communication, massive device connectivity, and enhanced mobile broadband speeds.

At the heart of this connectivity lies the Radio Access Network (RAN). The RAN is the part of the network that connects mobile devices to the core network using radio signals. It comprises base stations (such as macro towers and small cells) that communicate directly with user equipment like smartphones, tablets, and IoT devices. Traditional RAN architectures were built with proprietary hardware and software, often tied to a single vendor. While effective for simpler networks, this approach limits flexibility, scalability, and interoperability in a world demanding diverse services and increasing data traffic.

To address these challenges, the industry has generally moved toward Open Radio Access Networks (O-RAN). O-RAN is a new architectural framework that disaggregates traditional RAN components into modular elements with standardized open interfaces. This approach allows operators to mix and match components from different vendors, fostering innovation and reducing costs. O-RAN also incorporates advanced intelligence and automation, leveraging technologies like artificial intelligence and machine learning to optimize network performance dynamically.

The need for O-RAN arises from the complexity and diversity of modern network demands. Unlike earlier generations, 5G networks must support a wide array of use cases, including enhanced mobile broadband (eMBB) for high-speed internet, massive machine-type communication (mMTC) for IoT devices, and ultra-reliable low-latency communication (URLLC) for applications like autonomous vehicles and remote surgeries. Managing these diverse requirements across shared infrastructure requires protocols and frameworks like O-RAN, which provide the flexibility and intelligence needed to allocate resources efficiently and dynamically.

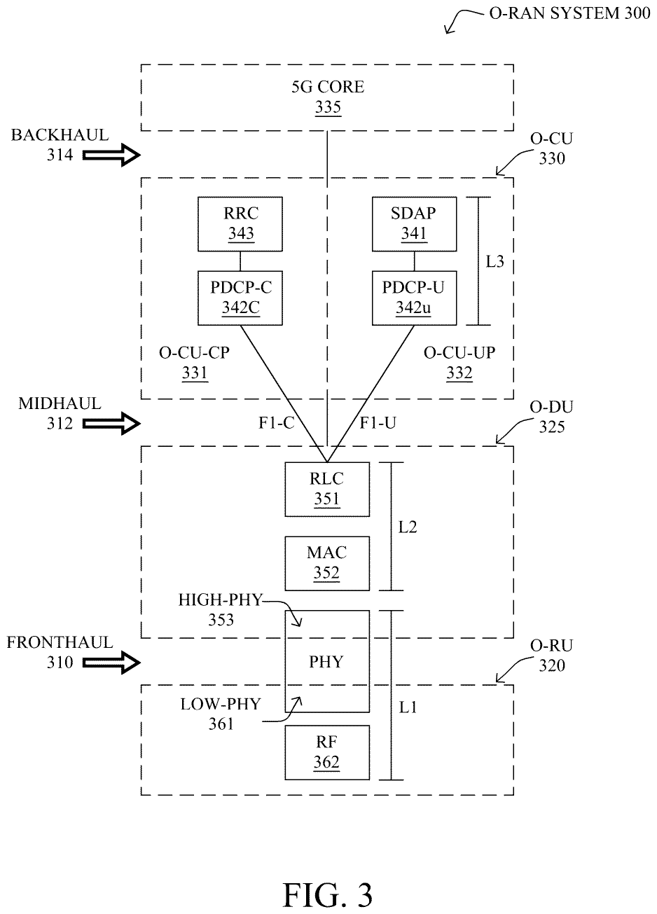

FIG. 3 illustrates an example O-RAN system 300, showcasing disaggregation and open interfaces that promote flexibility, scalability, and vendor interoperability, as noted above. In particular, the transport layers within the RAN include a fronthaul 310, a midhaul 312, and a backhaul 314. These layers/terms define the interfaces connecting different components of the network:
Fronthaul 310 connects the O-RU 320 (O-RAN Radio Unit) to the O-DU 325 (O-RAN Distributed Unit). Traditionally, this interface has been proprietary, relying on protocols like Common Public Radio Interface (CPRI) and enhanced CPRI (eCPRI). O-RAN aims to standardize and open this interface to ensure interoperability between vendors, creating an open eCPRI standard.
Midhaul 312 links the O-DU 325 to the O-CU 330 (O-RAN Central Unit). This interface is standardized by 3GPP and commonly referred to as the “F1” interface (shown divided into control “F1-C” and user “F1-U” interfaces). It facilitates communication between the digital processing units of the RAN.
Backhaul 314 is the connection between the O-CU 330 and the network core 335 (e.g., 5G as shown). This interface has traditionally been open and handles the flow of data between the RAN and the core network. In legacy networks, this would be the connection between the baseband unit (BBU) and the core.

Within O-RAN, the 5G New Radio (NR) protocol stack is divided among several key components, each handling specific layers of communication. First, the O-CU 330 (O-RAN Central Unit) manages the higher layers of the protocol stack, including:
Service Data Adaptation Protocol (SDAP) 341 maps Quality of Service (QoS) flows to data radio bearers and tags uplink/downlink packets with QoS flow IDs;
Packet Data Convergence Protocol (PDCP) (split into PDCP-C 342c and PDCP-U 342u) maps packet data units to logical channels and manages user/control data transmission; and
Radio Resource Control (RRC) 343 is responsible for managing connections, mobility, and system information broadcasts.

Also, the O-CU 330 is further divided into i) the O-CU-CP (Control Plane) 331 to handle control-specific tasks like RRC and PDCP-C, and ii) the O-CU-UP (User Plane) 332 to manage user-specific data flows through SDAP and PDCP-U.

Second, the O-DU 325 (O-RAN Distributed Unit) hosts the lower layers of the protocol stack, including:
Radio Link Control (RLC) 351, which manages error correction through Automatic Repeat Requests (ARQ), sequence numbering, and upper-layer data transfer;
Media Access Control (MAC) 352, which maps transport and logical channels, performs multiplexing, and corrects errors using Hybrid ARQ (HARQ); and
High-PHY Layer 353, which handles upper-level physical processing, interfacing the MAC with the physical layer.

Third, the O-RU 320 (O-RAN Radio Unit) is responsible for the Low-PHY layer and radio frequency (RF) processing 362, converting digital signals to analog for over-the-air transmission.

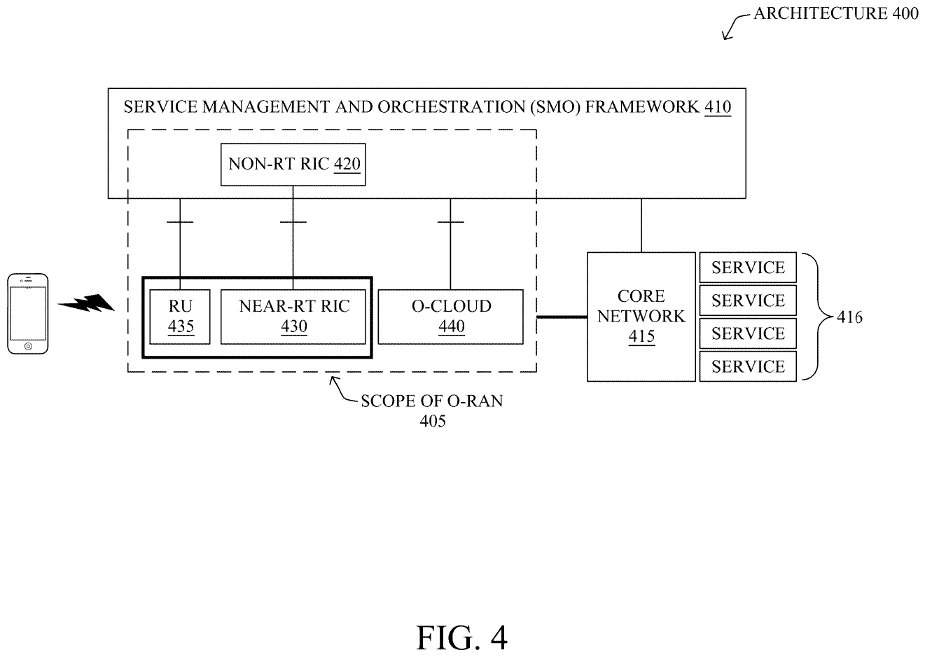

FIG. 4 illustrates a typical mobile network (O-RAN) architecture (architecture 400) from the management point of view. In particular, the Service Management and Orchestration (SMO) system and the RAN Intelligent Controllers (RICs) are key components of the O-RAN architecture, providing essential capabilities for managing, optimizing, and orchestrating the network.

The SMO framework 410 is the central management entity for the RAN domain. It oversees tasks such as configuration, performance monitoring, and lifecycle management of O-RAN functions 405. Beyond the RAN, the SMO integrates with other management domains like core network 415 (offering associated services 416), as well as transport and end-to-end slicing management, ensuring holistic control and coordination across the entire mobile network.

Within the SMO, the Non-Real-Time RAN Intelligent Controller (Non-RT RIC 420) plays a critical role in long-term optimization and policy management. Operating with latencies greater than one second, the Non-RT RIC drives high-level decisions. It comprises a framework and rApps (Non-RT RIC Applications), which use advanced analytics, AI, and machine learning to deliver insights and generate policy-based guidance for the RAN.

Complementing the Non-RT RIC, the Near-Real-Time RIC (Near-RT RIC 430) focuses on immediate control and optimization of RAN elements, such as RUs 435. Operating with control loops ranging from 10 milliseconds to one second, the Near-RT RIC enables fine-grained, responsive adjustments to network conditions. It collects detailed telemetry data and executes targeted actions to optimize resource allocation, traffic management, and overall network performance in real-time.

The O-RAN Cloud, or O-Cloud 440, provides the physical and virtual infrastructure needed to support these components. Defined by the O-RAN Alliance, the O-Cloud is a cloud computing platform built to meet the specific requirements of O-RAN. It hosts critical functions like the O-CU (Central Unit), O-DU (Distributed Unit), and other RAN components. The O-Cloud's open architecture ensures scalability, flexibility, and vendor interoperability. By enabling these functions to run in a virtualized and disaggregated manner, the O-Cloud supports the dynamic and efficient operation of the O-RAN system.

Notably, while the above description is directed to 5G, RAN, and O-RAN, other configurations and types of networks may be used herein, and the embodiments of the present disclosure are not limited accordingly. For example, while O-RAN refers to an open architecture for radio access networks (RANs) that allows for greater vendor flexibility, private 5G, as noted below, refers to a dedicated 5G network operated by a single entity, like a company, for their own exclusive use, and can be built using O-RAN technology as one option for its infrastructure.

### Hierarchical Shared Risk Modeling for Private 5G Services

As noted above, 5G networks are rapidly being deployed worldwide as the next generation of mobile internet connectivity, offering significantly faster speeds, reduced latency, and more reliable connections. With speeds ranging from 100Mbps to 20Gbps (e.g., up to a thousand times faster than 4G LTE) and average download speeds of approximately 1Gbps, 5G has also emerged as a viable alternative for broadband internet access in homes and businesses through fixed wireless access, replacing traditional fixed-line infrastructure. Additionally, 5G technology is expected to reduce network delay by 75%, from 40 milliseconds in 4G to just 10 milliseconds for enhanced mobile broadband applications.

One of the key advantages of 5G is its ultra-low latency, which can be as low as 10 milliseconds—60 to 120 times lower than that of 4G. This reduced latency enables real-time applications such as virtual reality (VR), autonomous vehicles, and a vast array of IoT-connected devices. Other benefits include lower network congestion, expanded coverage, increased device density, and exceptionally high bandwidth availability per user. Furthermore, 5G networks have been successfully extended to private 5G deployments and a “5G as a Service” (5GaaS) model. The fundamental components of a 5G network include user equipment (UE) such as mobile phones, IoT devices, and enterprise hardware; a radio access network (RAN) capable of receiving and translating 5G NR signals into IP/Ethernet traffic toward the 5G evolved packet core (EPC); and the 5G core network itself, which consists of routers with IP and segment routing capabilities that connect to the internet, servers, and machine-to-machine (M2M) end devices.

The applications of 5G span a wide range of industries, from basic mobile phone services to high-end healthcare, industrial automation, robotics, and autonomous vehicles. However, failures in any critical 5G network component can have catastrophic consequences, potentially creating life-threatening risks. For instance, a failure in a 5G network component supporting an autonomous vehicle or a real-time heart rate monitor could lead to severe safety hazards. To mitigate such risks, the concept of “shared risk groups” (SRG) has been introduced, wherein a set of devices is grouped together based on a shared dependency, meaning that failure of a specific resource may affect all devices within that group.

For example, two or more RAN edge switching or routing devices that share a common power infrastructure would form a shared risk group (SRG), where the failure of the power source would simultaneously impact multiple private 5G slices. Similarly, two fiber optic cables housed within the same conduit form a shared risk link group (SRLG), and failure of the conduit could disrupt a massive amount of EPC traffic traversing those links. Recognizing shared risks at every layer of the 5G network is crucial for improving resilience against failures. Shared risks exist in various forms, including common power sources, shared fiber and cable infrastructure, and common hardware components such as line cards hosting multiple uplinks and downlinks.

Despite the significance of shared risk in 5G networks, there is currently no effective method for modeling and assessing shared risks in the provisioning of private 5G services and 5G as a Service (5GaaS) offerings.

The techniques herein, therefore, address that gap by proposing a method to model shared risks within private 5G services and the 5GaaS framework. The proposed model enables targeted optimizations and user alerts at any layer of the end-to-end 5G architecture, thereby enhancing network resilience and reliability. That is, the techniques herein present a novel framework to address these critical issues, ensuring robust risk management for enterprise 5G deployments.

Particularly, the techniques herein provide hierarchical shared risk modeling for private 5G services, where a private 5G service offering and 5G as a Service (5GaaS) model serve multiple enterprise-grade customers, each relying on complex network infrastructures with shared dependencies across various components. The techniques herein provide a structured approach to quantifying and modeling shared risks within these networks, both proactively before deployment and dynamically after implementation. By systematically assessing these risks, the methods enable optimization and mitigation strategies to enhance network resilience and reliability for private 5G services. In other words, these techniques introduce a comprehensive risk assessment framework that identifies potential failure points and shared dependencies across a private 5G network. By leveraging a hierarchical risk model and automated analysis, network operators can anticipate vulnerabilities, prevent cascading failures, and optimize service reliability—ensuring seamless operation for enterprise customers relying on mission-critical 5G connectivity.

Specifically, according to one or more embodiments of the disclosure as described in detail below, an illustrative method herein may comprise: identifying shared risk entities within a layered network topology, each shared risk entity of the shared risk entities corresponding to a network component of the layered network topology associated with a common failure dependency; assigning a shared risk parameter to each shared risk entity, wherein the shared risk parameter comprises a shared risk type and an associated shared risk value; constructing a hierarchical shared risk model representing dependencies among the shared risk entities across multiple layers of the layered network topology, wherein the hierarchical shared risk model defines risk propagation paths between the shared risk entities according to the dependencies; and storing the hierarchical shared risk model as a data structure with each shared risk entity represented with a key-value pair comprising a respective shared risk type and respective shared risk value.

In one embodiment, as described in greater detail below, the method herein further comprises: determining a failure event associated with at least one shared risk entity in the hierarchical shared risk model; and computing a risk impact assessment by analyzing risk propagation through the hierarchical shared risk model, wherein the risk impact assessment identifies downstream network components of the layered network topology affected by the failure event. In one embodiment the method herein further comprises: generating a shared risk visualization that represents the risk impact assessment, wherein the shared risk visualization illustrates affected and unaffected network components within the hierarchical shared risk model. In one embodiment the method herein further comprises: performing at least one risk mitigation action based on the risk impact assessment.

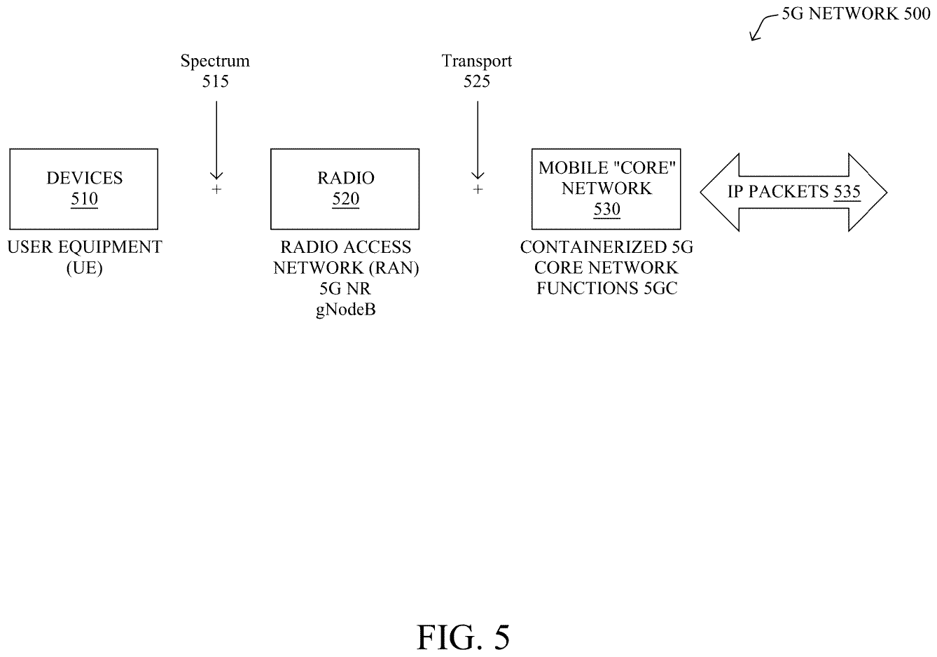

Briefly, FIG. 5 illustrates a simplified view of a 5G network 500. As shown, devices 510, such as user equipment (UE) (e.g., mobile phones), IoT devices, enterprise devices, etc., communicate (over spectrum 515) with a radio network 520, i.e., a radio access network (RAN), which may be composed of provisions to receive 5G “new radio” (NR) signals (e.g., through connections to gNode base stations (gNodeBs or gNBs)) and then translate those signals to IP packets and/or ethernet frames towards the 5G Evolved Packet Core (EPC). That is, radio network 520 then uses one or more transport protocols 525 to send the IP/ethernet data to a 5G core network 530, which may have containerized 5G core network functions (5GC) that utilize routers with IP/Segment routing capability to connect the data (e.g., IP packets 535) to the internet/servers/IoT servers/M2M (machine-to-machine) end devices (not shown for clarity).

Operationally, and as described in greater detail below, the techniques herein provide a comprehensive approach to quantifying, modeling, and mitigating shared risks in private 5G services and 5G as a Service (5GaaS) deployments. Given that these services cater to multiple enterprise customers, ensuring network resilience and reliability is critical. Shared risks exist at various levels of the 5G network infrastructure, including power dependencies, shared fiber links, and common hardware resources, all of which can lead to service degradation or failure. To address these challenges, the techniques herein implement a structured shared risk modeling framework that operates across multiple layers of the 5G network, from the core infrastructure to user equipment (UE).

According to the present disclosure, the techniques herein are first directed to shared risk modeling for private 5G services and a 5GaaS model. The shared risk modeling framework (e.g., a mathematical model) illustratively consists of two primary approaches: i) a manual numerical risk assignment model and ii) a controller-based hierarchical shared risk model (C-HSRM) (e.g., across end-to-end private 5G service/5GaaS).

The first approach allows for direct assignment of risk values to individual network components based on predefined shared risk entities (i.e., the shared risk is represented as a numerical value). In this model, on each device on the given private 5G service (e.g., edge devices, core devices, RAN devices, routers, switches, etc.), each shared risk entity is defined by a unique parameter, such as a common power source, shared fiber link, or hardware component, and is assigned a corresponding positive integer value (e.g., assigned by a user or otherwise).

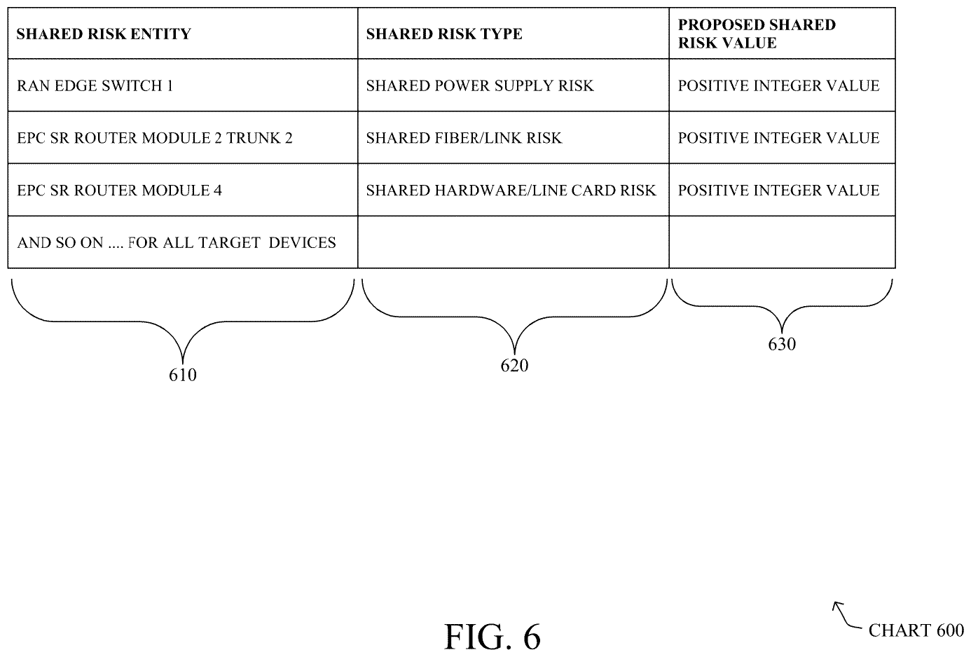

FIG. 6 illustrates a chart 600 of shared risk categorization by listing various shared risk entities 610 alongside their corresponding shared risk types 620 and assigned values, proposed shared risk values 630. Examples include Shared Power Supply Risks (e.g., affecting RAN Edge Switch 1), Shared Fiber/Link Risks (e.g., affecting EPC SR Router Module 2 Trunk 2), and Shared Hardware/Line Card Risks (e.g., affecting EPC SR Router Module 4). This structured representation enables precise risk modeling and facilitates both manual and automated risk assessments.

For example, if two RAN edge switches or routers at a specific deployment site (e.g., “site-1”) share a common power feed from a same power supply, both would be assigned the same Shared Power Supply Risk Value to reflect their dependency on that power source. This numerical modeling enables service providers to assess potential risk factors for any given network segment.

The second approach/model introduces a controller-driven hierarchical shared risk model (C-HSRM), which defines and tracks shared risks at different layers (e.g., every layer) of the 5G architecture (i.e., defining the associated risk values, accordingly). In this model, a given shared risk parameter may be represented as a shared risk parameter and shared risk parameter key value pair.

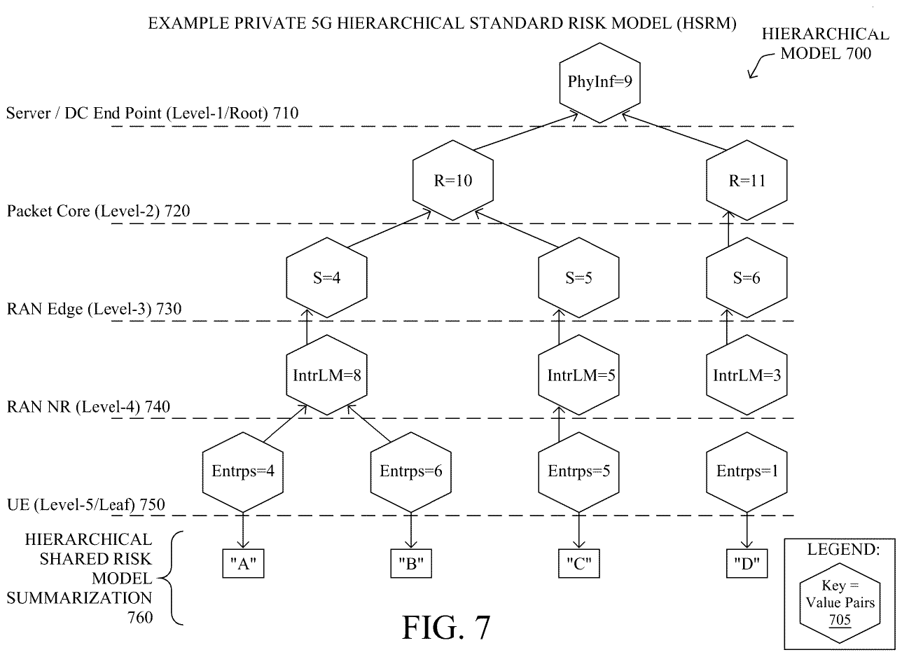

FIG. 7 illustrates how this hierarchical model 700 is represented as a hierarchical tree, where shared risks are mapped across levels, illustratively beginning from the Server/Data Center (Root Level, Level 1 710) and extending through the Packet Core (Level 2 720) 720, RAN Edge (Level 3 730), RAN NR (Level 4 740), and UE (Leaf Nodes, Level 5 750). Each node within the hierarchy corresponds to a network entity, with risk parameters assigned at each level and propagated through the structure. As noted, the shared risk type and its corresponding value are stored in a key-value pair format, key-value pairs 705, enabling efficient risk tracking and management.

In particular, the root of the model (Level 1 710) represents an end point server, DC end point, or any other enterprise end point of 5G network. This model can be extended to any other potential physical infra entity at the root layer as per the design/customer needs such as cooling/air conditioning, racks, storage, power distribution etc.

The shared risk at root can be anything, though in the current example physical infrastructure (“PhyInf”) is considered as an example risk at the root (e.g., key-value pair “PhyInf=9”). Each of the listed parameters in the diagram is defined at the controller layer and will have a key-value pair association, where the model has defined the Shared Risk Type and associated shared risk value. The model also proposes that the given shared risk type is created at the controller layer and the controller is enabled to assign the initial value and manage the shared risk type lifetime behavior. The model also proposes that the shared risk type which controller is capable of maintaining by system control can also be instead allowed to be user configurable/user controlled if needed. As shown, Level-2, Level-3, and so on show the various target 5G connectivity/RAN/fronthaul/mid-haul/backhaul/backbone and SR and access layers that are targeted in the middle layers of the proposed model. The shared risk at the following layers is considered in the example model as:
Shared SR packet Core Router layer Risk;
Shared RAN Edge Switch Layer Risk;
Shared NR radio/RAN air interface Hardware Modules/Uplink interfaces Risk;
Shared UE User equipment risk as a leaf end of the example model Notably, each of the above parameter is defined at the controller layer and will have a key-value pair association.

As an illustration, assume the following shared risks, definitions, and assignments according to the illustrative model shown in FIG. 7:
Level 1 710:
   shared risk: physical infrastructure;
   proposed risk definition:
      shared power risk (SPR)—system assigned or user assigned N bit field;
      shared cabling/fibering risk—system assigned or user assigned N bit field;
   proposed risk definition assignment: controller/user assigned.
Level 2 720:
   shared risk: SR based 5G core routers;
   proposed risk definition: 5GCoreR user assigned N bit field;
   proposed risk definition assignment: controller/user assigned.
Level 3 730:
   shared risk: 5G RAN Edge Switch;
   proposed risk definition: 5GRanSW user assigned N bit field;
   proposed risk definition assignment: controller/user assigned.
Level 4 740:
   shared risk: NR radio 5G—RAN to user Air Interface;
   proposed risk definition: IntrLM Interface—system assigned N bit field;
   proposed risk definition assignment: controller/user assigned.
Level 5 750:
   shared risk: Enterprise UE/User Equipment;
   proposed risk definition: Entrps/UE ID—system assigned N bit field;
   proposed risk definition assignment: controller/user assigned.

Moreover, assume the following hierarchical shared risk model summarizations beneath each illustrative leaf of Level 5:
Summarization “A”:
   Level-1/Root: Physical Infra: Value=0001:1001;
   Level-2: 5GCoreR: Value=0010:1010;
   Level-3: 5GRanSW: Value=0011:0100;
   Level-4: IntrLM: Value=0100:1000;
   Level-5/Leaf: Entrps/UE ID: Value=0101:0100.
Summarization “B”:
   Level-1/Root: Physical Infra: Value=0001:1001;
   Level-2: 5GCoreR: Value=0010:1010;
   Level-3: 5GRanSW: Value=0011:0100;
   Level-4: IntrLM: Value=0100:1000;
   Level-5/Leaf: Entrps/UE ID: Value=0101:0110.
Summarization “C”:
   Level-1/Root: Physical Infra: Value=0001:1001;
   Level-2: 5GCoreR: Value=0010:1010;
   Level-3: 5GRanSW: Value=0011:0101;
   Level-4: IntrLM: Value=0100:1000;
   Level-5/Leaf: Entrps/UE ID: Value=0101:0101.
Summarization “D”:
   Level-1/Root: Physical Infra: Value=0001:1001;
   Level-2: 5GCoreR: Value=0010:1011;
   Level-3: 5GRanSW: Value=0011:0110;
   Level-4: IntrLM: Value=0100:0011;
   Level-5/Leaf: Entrps/UE ID: Value=0101:0001.

This model can be extended to any other potential Level entity at the level layer as per the design/customer needs such as pluggable, equipment vendor type, etc., in order to quantify the needed type of end-to-end risk for the private 5G service offering.

Further, the controller-based hierarchical shared risk model (C-HSRM) creates a hierarchical model which provides an end-to-end automated shared risk assessment for any given private 5G service offering over the end-to-end 5G network. Hence this model mathematically provides a complete visualization of the shared risk against each level in the 5G network, accordingly.

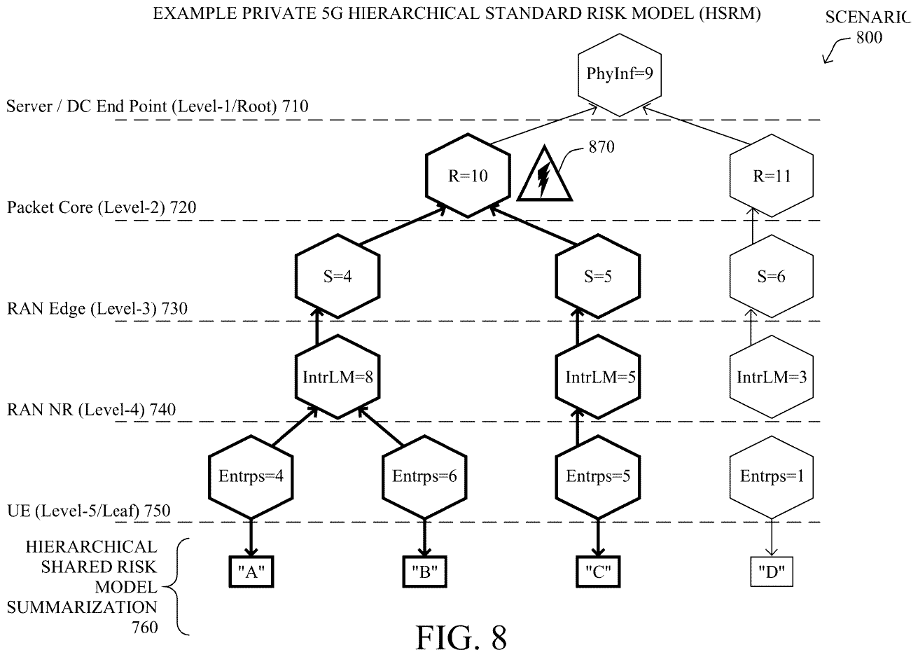

FIG. 8 now illustrates a scenario 800 visualizing the shared risk impact of a failure event 870 within this hierarchical shared risk model as in FIG. 7. Here, assume that the 5g Core packet “Router R10” at Level 2 undergoes a catastrophic failure, causing a cascading effect on all dependent network elements, highlighted in bolded outlines. As a result, the failure propagates downward, affecting RAN Edge switches (S4, S5), RAN NR modules (IntM4, IntM5), and ultimately the end-user devices (Enterp4, Enterp5). The hierarchical shared risk model maintained by the controller thus helps to visualize the impact down to the respective leaf/leaves (private 5G service/UE layer). The remaining network elements (not bolded) remain operational, indicating separate infrastructure paths unaffected by this particular failure.

This visualization, enabled by the hierarchical model, allows network operators to instantly assess the extent of failures and determine potential mitigations. Said differently, this information will help to understand and plan mitigation for the impact of a given failure either in runtime or in advance. That is, in the above example, the techniques herein also enable the controller to proactively plan the maintenance events. For example, in the event of Router R10 failure/proactive maintenance, the controller enables the network operator to understand which levels will get impacted and enables proactive actions to ensure to either minimize the impact or to take corrective actions as needed.

The controller-based model provides additional flexibility by allowing shared risk parameters to be dynamically updated based on real-time network changes. This includes modifications at both the root layer, where physical infrastructure risks (e.g., cooling, power distribution, storage) are considered, and at the mid and lower layers, where various networking elements (e.g., fronthaul, midhaul, backhaul, packet core, and radio access networks) are factored into the risk assessment. Furthermore, the model allows shared risk definitions to be either system-assigned, controller-managed, or user-defined, ensuring adaptability based on enterprise requirements.

In addition to failure assessment, the techniques herein also introduce an impact assessment mechanism for the proposed shared risk modelling that enables proactive planning and real-time optimizations as an outcome. This is highlighted above where the exact impact of a given layer device/module failure on all the candidate 5G service offerings can be assessed theoretically in advance as network virtualization/controller function. For instance, using the shared risk model, network operators can assess risks associated with specific network layers before deployment, allowing for “brownfield” placement decisions where the addition of new devices can be simulated in advance to minimize potential vulnerabilities. This functionality is particularly useful in large-scale private 5G deployments, where enterprises may need to strategically position hardware to reduce shared risk exposure. Additionally, automation capabilities within the hierarchical model allow for runtime optimizations, where risk values are adjusted dynamically in response to changes in network topology, device failures, or planned maintenance activities.

The hierarchical model also provides predictive analytics and proactive planning for maintenance events. As demonstrated above, by identifying shared risks across different layers, the controller can simulate the impact of scheduled maintenance activities and recommend mitigation strategies. For instance, before conducting maintenance on Router R10, the model can predict the network elements that will be impacted and provide alternative routing options to ensure minimal service disruption. This proactive approach enables better planning and operational efficiency for network operators managing large-scale private 5G deployments.

The following are examples of specific optimizations available through the techniques described within the present disclosure:
Corrective actions based on any target shared risk. Once the 5G network operator is aware of the target shared risks, they can plan suitable corrective actions such as reducing the shared risk for the most critical target assets or potentially create a safeguard to ensure risk minimization (e.g., if a shared power risk, then consider using distributed power sources, etc.).
Enable the end UE/Private 5G enterprise owner to have fine control over the target device (with respect of extent of shared risks and any needed modification). The techniques herein enable customizable modeling for risks against the target devices.
Brownfield device placement decision for any new device addition. The UE/Private 5G service consumer can visualize the risk model using controller in advance for a given planned placement for a new end device—This can enable the operator to take proper decision with regard to criticality and placement of the target new device.
Brownfield manual and automated optimization for new and existing device location/placement/connectivity/interaction with upper layers. The model enables end to end visualization and hence can automate the shared risk assessment and provide an optimized shared risk outcome model which can be helpful to evaluate the potential target changes to mitigate/minimize the shared risks.

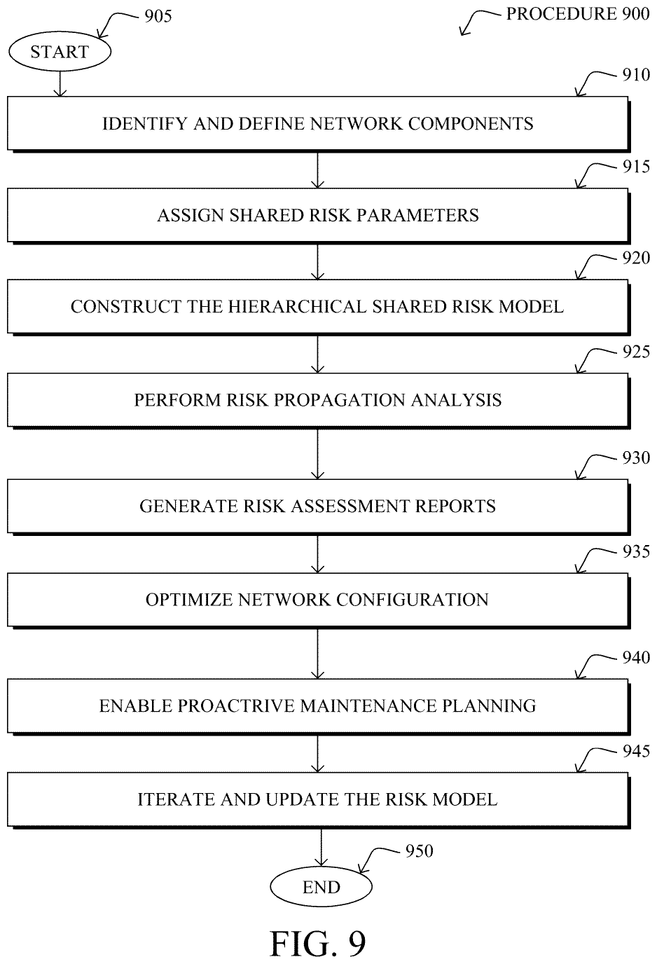

FIG. 9 illustrates an example high-level procedure (procedure 900) for implementing the hierarchical shared risk model described herein. The illustrative hierarchical shared risk modeling process starts at step 905, and continues to step 910 to identify and define all relevant network components, including core routers, RAN devices, and user equipment. In step 915, each network element is then assigned specific shared risk parameters, which may include dependencies on power sources, fiber links, or hardware resources. These risks can either be manually assigned using a numerical model or dynamically determined through a controller-based model that systematically tracks risk propagation across the network. Once risk parameters have been established, a hierarchical shared risk model is constructed in step 920, mapping these risks in a structured manner across different network layers. This model organizes shared risk information in a key-value pair format, allowing for systematic tracking and retrieval of risk data, as described in greater detail above.

With the hierarchical model in place, risk propagation analysis is performed in step 925 to assess the potential consequences of failures at different layers of the network. By simulating various failure scenarios, the model identifies how disruptions at specific nodes impact downstream components, enabling a comprehensive evaluation of network vulnerabilities. The results of this analysis are then compiled into risk assessment reports in step 930 that visually depict the relationships between shared risks and their dependencies. These reports help network operators identify critical risk points and make informed decisions about network resilience strategies.

Following the risk assessment, the network configuration may be optimized in step 935 to minimize exposure to high-risk dependencies. This includes adjusting risk values dynamically in response to real-time network conditions, implementing automated corrective actions such as rerouting traffic, and redistributing workloads to maintain service continuity. Proactive maintenance planning in step 940 is also a key (yet optional) component of the process, as the model enables predictive analytics to assess the impact of scheduled maintenance events. Before performing maintenance on critical network components, the model simulates the expected risk implications and provides recommendations for preemptive actions that can mitigate service disruptions.

Finally, in step 945 the shared risk model may be continuously updated and refined as network conditions evolve. As new devices are added, existing infrastructure is upgraded, or network policies change, risk parameters are reassessed and adjusted accordingly. This iterative approach ensures that the shared risk model remains aligned with the dynamic nature of private 5G deployments, providing ongoing risk visibility, proactive failure mitigation, and continuous optimization of network resilience strategies. The illustrative procedure (procedure 900) may then end in step 950, with the ability to continue iterating, generating reports, and so on, as described in the steps above.

The following real-life implementation scenarios demonstrate how the techniques herein could be advantageously utilized by network operators in various situations.

For instance, in a first example (e.g., preventing service disruptions in a smart hospital), assume that a large metropolitan hospital has deployed a private 5G network to support real-time patient monitoring, robotic-assisted surgeries, and autonomous hospital logistics, including AI-driven medication dispensers. The network relies on multiple RAN edge switches that share a common power infrastructure and several packet core routers that route medical data to centralized servers. Using the hierarchical shared risk model, the hospital's network administrator identifies that a single power distribution unit failure could simultaneously take down both RAN edge switches, disrupting communication between medical devices and the data center. By leveraging the controller-based hierarchical shared risk model (C-HSRM), the hospital network operator proactively redistributes power loads and provisions an alternative routing path for critical patient monitoring devices. Later, when a planned power system upgrade requires temporarily shutting down the original power unit, the network dynamically shifts traffic to redundant pathways, ensuring zero downtime for life-critical applications. Had this risk model not been implemented, a single power failure could have caused catastrophic disruptions—potentially leading to delays in life-saving procedures, loss of real-time patient vitals, and failures in robotic-assisted surgeries. Without proactive risk assessment, the IT team would have been unaware of this shared risk and unable to take mitigating steps, resulting in widespread service failures during the maintenance window.

In a second example, (e.g., ensuring uptime in an autonomous manufacturing facility), assume here that an advanced automotive manufacturing facility operates a private 5G network to manage its fleet of autonomous vehicles transporting parts across the assembly line. The network relies on low-latency 5G connectivity between the self-driving forklifts, centralized control servers, and robotic arms executing precision assembly tasks. The facility's network consists of multiple fronthaul and midhaul fiber links, several of which run through the same conduit. Using the shared risk modeling techniques, the network operator identifies that two of the four fiber links share the same physical conduit, making them vulnerable to simultaneous failure in the event of a conduit cut due to construction or accidental damage. Based on this assessment, the network administrator reconfigures the routing strategy to ensure that the most critical production traffic (e.g., including real-time vehicle coordination) is routed through separate, independent fiber paths. When a maintenance crew later severs the conduit containing the two shared links, the factory remains fully operational because traffic was automatically shifted to the redundant, unaffected paths. Without this shared risk assessment, the conduit failure could have led to a factory-wide shutdown, with autonomous vehicles losing connectivity, robotic assembly lines stalling, and production grinding to a halt, potentially costing millions in lost revenue. The factory's ability to quickly assess and mitigate shared risks ensured business continuity and seamless production.

In a third example (e.g., protecting an enterprise financial network from infrastructure failures), assume that a global financial institution deploys a private 5G network to handle secure, low-latency transactions across its trading floors, data centers, and disaster recovery sites. The network relies on a core set of enterprise routers that connect trading terminals to the institution's private cloud infrastructure. The hierarchical shared risk model reveals that several of these routers share the same hardware line card, meaning a failure of that card would disrupt all connected trading servers simultaneously. With this knowledge, the IT team implements a proactive mitigation strategy, introducing redundant hardware configurations and ensuring that critical trading servers are load-balanced across multiple independent network paths. Additionally, the shared risk model enables real-time failure visualization, allowing the team to simulate the impact of a core router failure and refine their response protocols. When a router module eventually fails due to a hardware malfunction, the network seamlessly transitions to redundant paths, preventing trading disruptions. Had this shared risk model not been in place, the failure could have resulted in multi-million-dollar financial losses due to halted trading activity and an inability to execute time-sensitive transactions. By preemptively identifying shared risk dependencies, the institution was able to maintain network stability and ensure uninterrupted operations.

In each of these real-world scenarios, the techniques herein provide proactive risk identification, impact assessment, and dynamic mitigation strategies to ensure uninterrupted network service. By modeling shared risks across power infrastructure, fiber links, and hardware dependencies, network operators gain end-to-end visibility into potential failure points, allowing them to take preemptive action before disruptions occur. Without these techniques, enterprises would face unanticipated network failures, costly downtime, and potential safety hazards, as failure points would remain hidden until catastrophic disruptions arise. The shared risk modeling framework ultimately enhances operational resilience, improves service availability, and ensures that private 5G networks deliver on their promise of ultra-reliable connectivity.

Notably, a key advantage of these techniques is their integration with macro-diversity principles, which involve multiple transmitters and receivers providing redundancy to improve 5G network reliability. Macro-diversity generally focuses on enhancing signal robustness through redundant transmission paths, whereas the hierarchical shared risk model ensures that even with redundancy, the underlying infrastructure risks are identified and mitigated. For example, in a scenario where multiple diversity paths exist, the controller-based model can assess the risk of shared dependencies across those paths, allowing operators to make informed decisions regarding failover strategies. By integrating shared risk modeling with macro-diversity techniques, overall 5G network reliability is significantly improved.

In closing, the techniques herein introduce a novel approach to modeling and mitigating shared risks in private 5G networks and 5G as a Service (5GaaS) models. At the core of this approach is a structured hierarchical shared risk model (HSRM) that provides a dynamic and automated method for defining and assessing shared risks across all layers of a 5G network, from user equipment (UE) to the radio access network (RAN), packet core, and data center endpoints. The model supports both manual risk assignment, where users directly specify risk parameters for individual network components, and a controller-based hierarchical shared risk model (C-HSRM) that autonomously defines risk values, tracks dependencies, and adjusts risk assignments based on network changes. Shared risks are represented as key-value pairs that can be either system-controlled or user-configurable, enabling network operators to flexibly manage risks based on enterprise requirements.

A key advantage of this approach is its ability to quantify and visualize shared risks across an entire private 5G deployment, offering a real-time, end-to-end assessment of failure impact scenarios. The model supports multi-dimensional risk analysis, where each shared risk entity (e.g., a RAN edge switch, core router, or fiber link) can be associated with multiple independent risk factors, including power dependencies, fiber link vulnerabilities, and shared hardware resources. This granular modeling enables automated impact assessments, allowing operators to simulate failure events, predict affected network elements, and take corrective action in advance. The system further supports proactive risk simulation and programmable user alerts, ensuring that network operators and enterprise customers receive timely notifications when risk thresholds are exceeded.

By leveraging a controller-driven framework, the model enables automated risk mitigation, including dynamic reconfigurations of network paths, redistribution of workloads, and proactive maintenance planning. The model seamlessly integrates with macro-diversity and micro-diversity principles, ensuring that shared risk assessments complement existing redundancy strategies while identifying hidden dependencies that could otherwise compromise failover mechanisms. Additionally, it facilitates brownfield network optimizations, allowing operators to visualize and evaluate risk exposure when adding new devices, adjusting network topologies, or integrating new enterprise applications.

The techniques herein thus provide an advanced, visualized risk assessment platform that enables multiple simultaneous risk perspectives, supporting customizable root-node definitions and dynamic reconfiguration of hierarchical risk mappings. This ensures that risk assessments remain adaptable to changing network conditions, making them applicable to both static infrastructure and evolving network environments. Ultimately, these techniques provide a scalable, data-driven method for ensuring 5G network resilience, enabling enhanced reliability, lower service disruption risks, and optimized resource utilization for private 5G service providers and enterprise customers.

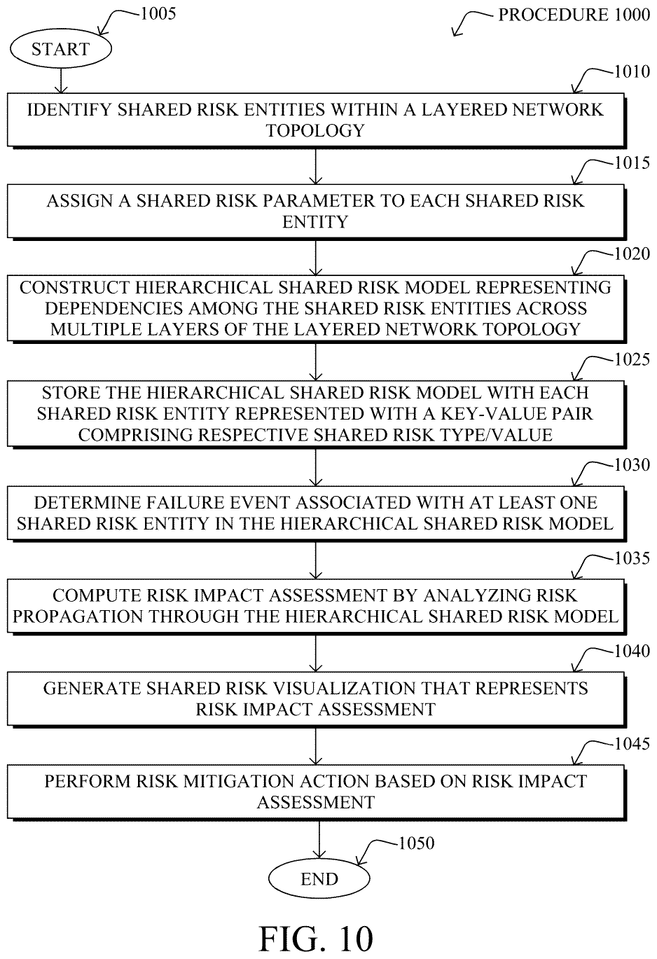

FIG. 10 illustrates an example simplified procedure (procedure 1000) for providing hierarchical shared risk modeling for private 5G services in accordance with one or more embodiments described herein. For example, a non-generic, specifically configured device (e.g., device 200, an apparatus) may perform procedure 1000 by executing stored instructions (e.g., process 248). The procedure 1000 may start at step 1005, and continues to step 1010, where, as described in greater detail above, the techniques herein identify shared risk entities within a layered network topology, each shared risk entity of the shared risk entities corresponding to a network component of the layered network topology associated with a common failure dependency. In one embodiment, the layered network topology comprises a private 5G network.

In step 1015, the process herein comprises assigning a shared risk parameter to each shared risk entity, wherein the shared risk parameter comprises a shared risk type and an associated shared risk value. In one embodiment, the respective shared risk type is selected from a group consisting of: power dependency, fiber link dependency, hardware component dependency, and software resource dependency. In one embodiment, the respective shared risk value is a numerical value that is either assigned manually by a user or automatically determined by the process based on system parameters.

The process continues to step 1020 where the process comprises constructing a hierarchical shared risk model representing dependencies among the shared risk entities across multiple layers of the layered network topology, wherein the hierarchical shared risk model defines risk propagation paths between the shared risk entities according to the dependencies. In one embodiment, the hierarchical shared risk model is constructed dynamically in response to real-time changes in the layered network topology.

In step 1025, the process comprises storing the hierarchical shared risk model as a data structure with each shared risk entity represented with a key-value pair comprising a respective shared risk type and respective shared risk value.

In one or more embodiments herein, in step 1030 the process may further comprise determining a failure event associated with at least one shared risk entity in the hierarchical shared risk model. In one embodiment, the failure event comprises one of either an actual failure event or a simulated failure event. In one embodiment, in step 1035, the process may comprise computing a risk impact assessment by analyzing risk propagation through the hierarchical shared risk model, wherein the risk impact assessment identifies downstream network components of the layered network topology affected by the failure event. In step 1040 the process may comprise generating a shared risk visualization that represents the risk impact assessment, wherein the shared risk visualization illustrates affected and unaffected network components within the hierarchical shared risk model. Moreover, in step 1045, the process may further comprise performing at least one risk mitigation action based on the risk impact assessment. In one embodiment, the at least one risk mitigation action is selected from a group consisting of: adjusting network configurations, rerouting network traffic, modifying power distributions, reconfiguring hardware dependencies, and reassigning workloads among multiple network slices. Furthermore, in one embodiment, the process may comprise applying network function virtualization techniques to simulate shared risk impacts before deploying new network components into the layered network topology.

Procedure 1000 may end at step 1050. In one embodiment, however, the process may further comprise dynamically adjusting the respective shared risk value in response to one or more of network reconfigurations, hardware upgrades, or detected infrastructure changes.

It should be noted that while certain steps within the procedures above may be optional as described above, the steps shown in the procedures above are merely examples for illustration, and certain other steps may be included or excluded as desired (such as, e.g., storing historical failure data and using predictive analytics on the historical failure data to anticipate future risk events; sending an automated alert in response to detection of a high-risk shared risk value; and so on). Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: identifying shared risk entities within a layered network topology, each shared risk entity of the shared risk entities corresponding to a network component of the layered network topology associated with a common failure dependency; assigning a shared risk parameter to each shared risk entity, wherein the shared risk parameter comprises a shared risk type and an associated shared risk value; constructing a hierarchical shared risk model representing dependencies among the shared risk entities across multiple layers of the layered network topology, wherein the hierarchical shared risk model defines risk propagation paths between the shared risk entities according to the dependencies; and storing the hierarchical shared risk model as a data structure with each shared risk entity represented with a key-value pair comprising a respective shared risk type and respective shared risk value.

In still other implementations, a tangible, non-transitory, computer-readable medium storing program instructions that cause a device to execute a process comprising: identifying shared risk entities within a layered network topology, each shared risk entity of the shared risk entities corresponding to a network component of the layered network topology associated with a common failure dependency; assigning a shared risk parameter to each shared risk entity, wherein the shared risk parameter comprises a shared risk type and an associated shared risk value; constructing a hierarchical shared risk model representing dependencies among the shared risk entities across multiple layers of the layered network topology, wherein the hierarchical shared risk model defines risk propagation paths between the shared risk entities according to the dependencies; and storing the hierarchical shared risk model as a data structure with each shared risk entity represented with a key-value pair comprising a respective shared risk type and respective shared risk value.

The techniques described herein, therefore, provide for hierarchical shared risk modeling for private 5G services. By implementing a structured shared risk modeling framework, these techniques provide advantages for private 5G service providers and enterprise customers. The hierarchical risk model ensures comprehensive network visibility, enabling operators to proactively identify and mitigate risks before they result in failures. The integration of automated risk assessment, predictive failure modeling, and dynamic optimizations allows for enhanced resilience, reducing downtime and ensuring high service availability. Additionally, the ability to visualize failure propagation in real-time provides crucial insights for network operators, facilitating better decision-making in risk-sensitive environments such as autonomous vehicle networks and mission-critical IoT applications.

By bridging the gap between network reliability, shared risk management, and automation, these techniques offer a scalable, adaptable, and highly efficient approach to optimizing private 5G deployments. Through the combination of manual and controller-based risk modeling, enterprises can customize risk assessment methodologies while leveraging automation for real-time optimization and predictive failure mitigation. The result is a robust and resilient private 5G network architecture, capable of supporting critical enterprise applications with minimal risk exposure and maximum uptime.

Illustratively, the techniques described herein may be performed by hardware, software, and/or firmware, (e.g., an “apparatus”) such as in accordance with the shared risk modeling process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
identifying, by a process, shared risk entities within a layered network topology, each shared risk entity of the shared risk entities corresponding to a network component of the layered network topology associated with a common failure dependency;
assigning, by the process, a shared risk parameter to each shared risk entity, wherein the shared risk parameter comprises a shared risk type and an associated shared risk value;
constructing, by the process, a hierarchical shared risk model representing dependencies among the shared risk entities across multiple layers of the layered network topology, wherein the hierarchical shared risk model defines risk propagation paths between the shared risk entities according to the dependencies; and
storing, by the process, the hierarchical shared risk model as a data structure with each shared risk entity represented with a key-value pair comprising a respective shared risk type and respective shared risk value.

2. The method of claim 1, further comprising:
determining a failure event associated with at least one shared risk entity in the hierarchical shared risk model; and
computing a risk impact assessment by analyzing risk propagation through the hierarchical shared risk model, wherein the risk impact assessment identifies downstream network components of the layered network topology affected by the failure event.

3. The method of claim 2, further comprising:
generating a shared risk visualization that represents the risk impact assessment, wherein the shared risk visualization illustrates affected and unaffected network components within the hierarchical shared risk model.

4. The method of claim 2, further comprising:
performing at least one risk mitigation action based on the risk impact assessment.

5. The method of claim 4, wherein the at least one risk mitigation action is selected from a group consisting of: adjusting network configurations, rerouting network traffic, modifying power distributions, reconfiguring hardware dependencies, and reassigning workloads among multiple network slices.

6. The method of claim 2, wherein the failure event comprises one of either an actual failure event or a simulated failure event.

7. The method of claim 1, further comprising:
applying network function virtualization techniques to simulate shared risk impacts before deploying new network components into the layered network topology.

8. The method of claim 1, wherein the layered network topology comprises a private 5G network.

9. The method of claim 1, wherein the hierarchical shared risk model is constructed dynamically in response to real-time changes in the layered network topology.

10. The method of claim 1, wherein the respective shared risk type is selected from a group consisting of: power dependency, fiber link dependency, hardware component dependency, and software resource dependency.

11. The method of claim 1, wherein the respective shared risk value is a numerical value that is either assigned manually by a user or automatically determined by the process based on system parameters.

12. The method of claim 1, further comprising:
dynamically adjusting the respective shared risk value in response to one or more of network reconfigurations, hardware upgrades, or detected infrastructure changes.

13. The method of claim 1, further comprising:
storing historical failure data; and
using predictive analytics on the historical failure data to anticipate future risk events.

14. The method of claim 1, further comprising:
sending an automated alert in response to detection of a high-risk shared risk value.

15. A tangible, non-transitory, computer-readable medium storing program instructions that cause a device to execute a process comprising:
identifying shared risk entities within a layered network topology, each shared risk entity of the shared risk entities corresponding to a network component of the layered network topology associated with a common failure dependency;
assigning a shared risk parameter to each shared risk entity, wherein the shared risk parameter comprises a shared risk type and an associated shared risk value;
constructing a hierarchical shared risk model representing dependencies among the shared risk entities across multiple layers of the layered network topology, wherein the hierarchical shared risk model defines risk propagation paths between the shared risk entities according to the dependencies; and
storing the hierarchical shared risk model as a data structure with each shared risk entity represented with a key-value pair comprising a respective shared risk type and respective shared risk value.

16. The tangible, non-transitory, computer-readable medium of claim 15, wherein the process further comprises:
determining a failure event associated with at least one shared risk entity in the hierarchical shared risk model; and
computing a risk impact assessment by analyzing risk propagation through the hierarchical shared risk model, wherein the risk impact assessment identifies downstream network components of the layered network topology affected by the failure event.

17. The tangible, non-transitory, computer-readable medium of claim 16, wherein the process further comprises:
generating a shared risk visualization that represents the risk impact assessment, wherein the shared risk visualization illustrates affected and unaffected network components within the hierarchical shared risk model.

18. The tangible, non-transitory, computer-readable medium of claim 16, wherein the process further comprises:
performing at least one risk mitigation action based on the risk impact assessment.

19. An apparatus, comprising:
one or more network interfaces to communicate with a network;
a processor coupled to the one or more network interfaces and configured to execute one or more processes; and
a memory configured to store a process that is executable by the processor, the process comprising:
identifying shared risk entities within a layered network topology, each shared risk entity of the shared risk entities corresponding to a network component of the layered network topology associated with a common failure dependency;
assigning a shared risk parameter to each shared risk entity, wherein the shared risk parameter comprises a shared risk type and an associated shared risk value;
constructing a hierarchical shared risk model representing dependencies among the shared risk entities across multiple layers of the layered network topology, wherein the hierarchical shared risk model defines risk propagation paths between the shared risk entities according to the dependencies; and
storing the hierarchical shared risk model as a data structure with each shared risk entity represented with a key-value pair comprising a respective shared risk type and respective shared risk value.

20. The apparatus of claim 19, wherein the process further comprises:
determining a failure event associated with at least one shared risk entity in the hierarchical shared risk model; and
computing a risk impact assessment by analyzing risk propagation through the hierarchical shared risk model, wherein the risk impact assessment identifies downstream network components of the layered network topology affected by the failure event.
